(19) United States
(12) Patent Application Publication
(10) Pub. No.: US 2022/0204132 A1
(43) Pub. Date: Jun. 30, 2022

(54) ELECTRIC WHEEL HUB

(71) Applicant: SOLID YEAR CO., LTD., New Taipei City (TW)

(72) Inventor: Herman HUANG, Taipei City (TW)

(21) Appl. No.: 17/498,928

(22) Filed: Oct. 12, 2021

(30) Foreign Application Priority Data
Dec. 28, 2020 (TW) 109146494

(51) Int. Cl. B62M 6/65; B60B 27/02; B60B 27/00

(52) U.S. Cl. CPC B62M 6/65; B60B 27/0005; B60B 27/0047; B60B 27/023

(57) ABSTRACT

An electric wheel hub is provided. The electric wheel hub includes a shell, a motor assembly and a battery unit. The motor assembly is disposed in the shell and has a stator, a rotor and a shaft. The shaft is detachably inserted within the stator. The rotor is rotatable with the shell and rotatable relative to the stator. The battery unit is disposed in the shell and electrically connected with the motor assembly. The battery unit has a cartridge and batteries positionally received within the cartridge.

### BACKGROUND OF THE INVENTION

### Field of the Invention

The present invention relates to an electric wheel hub.

### Description of the Prior Art

Bicycles were prevalent in many places. With the changes in lifestyles, the environmental awareness and the concept of physical fitness, bicycles are popularly used in daily lives. With development of technology, electric bicycles have been a booming trend, especially in cities. The electric bicycles can be roughly classified into types with hub motor and mid-mounted motor. The advantages of the type with hub motor are that it is compact and artistic in appearance, that the overall appearance of the bicycle is concise, that the price is low, that there is relatively lower level of requirement for the bicycle frame, and that there is relatively lower requirement for the chain, so the electric bicycles are popular around the world. TW M580517, TW M580522 and TW I701176 disclose the like electric bicycles.

However, the above-mentioned wheel hub motor has a complicated structure, many parts and components are interconnected, and it is difficult and time-consuming to dismantle and replace. Therefore, it needs a repairer who knows specific model of the wheel hub motor well to repair and/or replace the parts and components, which is inconvenient.

The present invention is, therefore, arisen to obviate or at least mitigate the above-mentioned disadvantages.

### SUMMARY OF THE INVENTION

The main object of the present invention is to provide an electric wheel hub which can greatly simplify the difficulty of maintenance and/or replacement.

To achieve the above and other objects, an electric wheel hub is provided, including: a shell, including a base and a cover, the base defining an interior space and a mounting entrance, the cover being mounted to the base in a mounting direction and covering the mounting entrance; a motor assembly, including a stator, a rotor and a shaft, the stator and the rotor being received within the shell by moving through the mounting entrance in the mounting direction, the stator and the rotor being relatively rotatable, the rotor being connected with the shell, the shaft being disposed within the shell in a direction opposite to the mounting direction and disposed through and connected with the stator, two ends of the shaft being configured to be respectively connected to two fork arms, the shaft defining an axial direction and a circumferential direction, the shaft and the stator being relatively movable in the axial direction, the shaft and the stator being relatively non-rotatable in the circumferential direction; and a battery unit, electrically connected with the motor assembly, including a cartridge and a plurality of batteries, the plurality of batteries being positionally received within the cartridge, the cartridge being received within the interior space by moving through the mounting entrance in the mounting direction, the cartridge being connected with the stator and disposed around the motor assembly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing an application of a preferable embodiment of the present invention;

FIG. 2 is a breakdown drawing of a preferable embodiment of the present invention;

FIG. 3 is a breakdown drawing of a battery unit and a circuit board according to a preferable embodiment of the present invention;

FIG. 4 is a breakdown drawing showing a shaft, two end caps and a stator of a preferable embodiment of the present invention;

FIG. 5 is a drawing showing the shaft and the stator combined according to a preferable embodiment of the present invention;

FIG. 6 is a drawing showing the shaft and the two end caps combined according to a preferable embodiment of the present invention; and

FIGS. 7-11 are drawings showing detachment of an electric wheel hub of a preferable embodiment of the present invention.

### DETAILED DESCRIPTION OF THE PREFERRED EMBODIMENTS

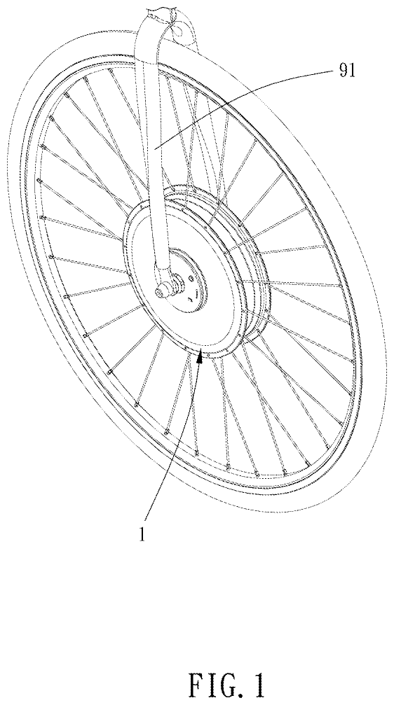

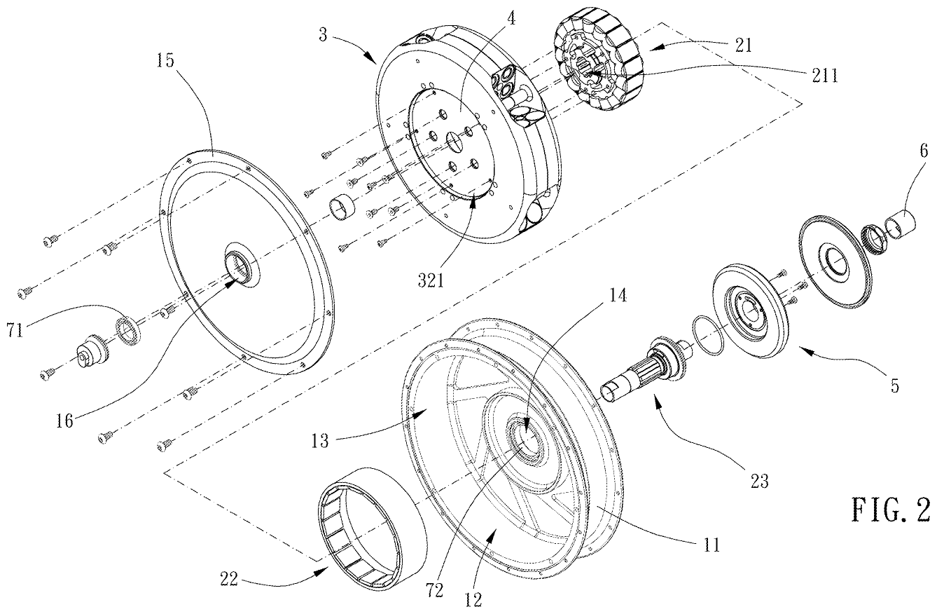

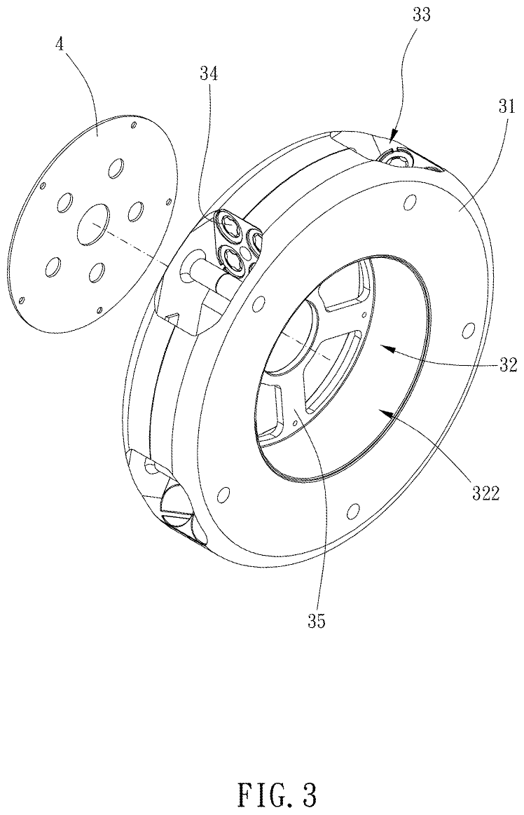

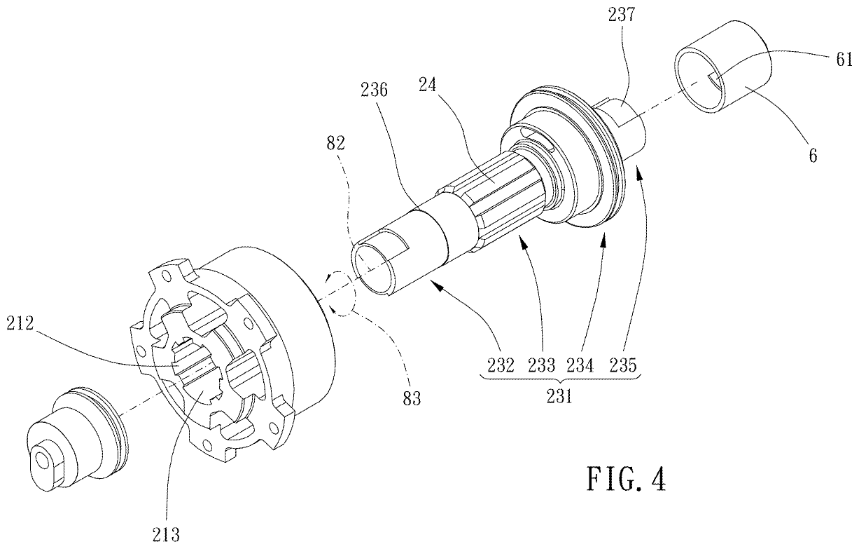

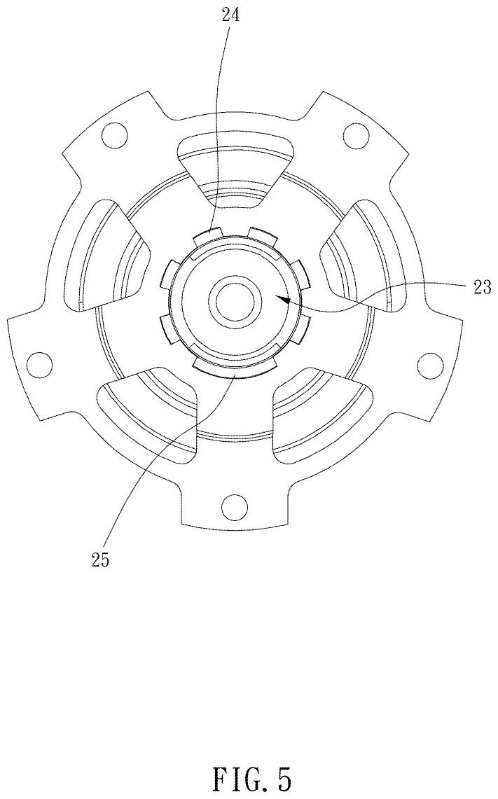

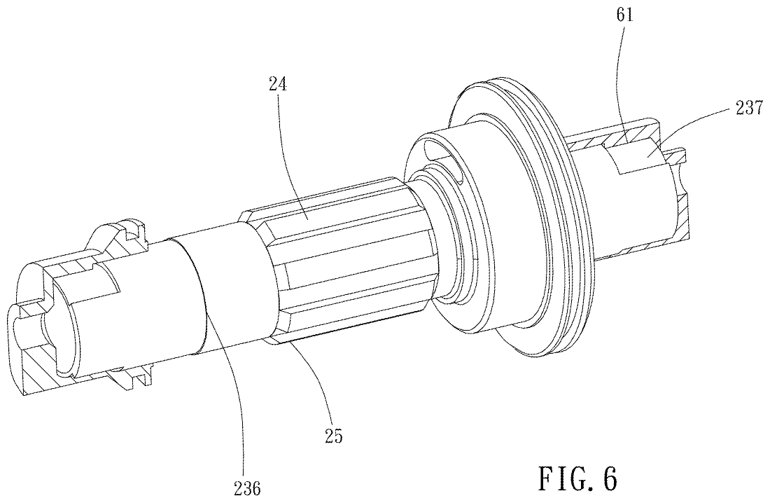

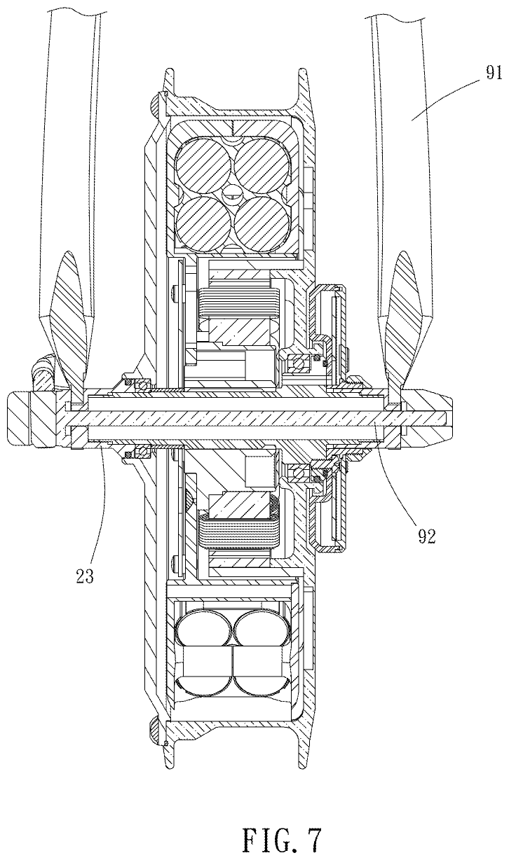

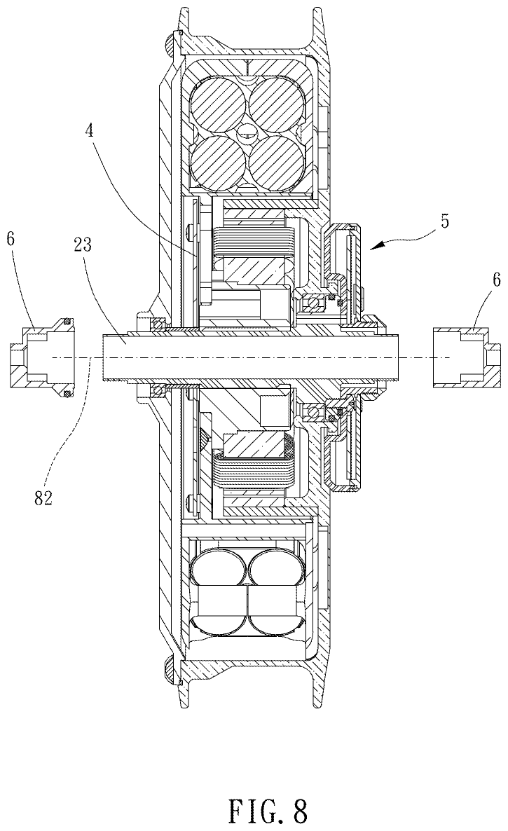

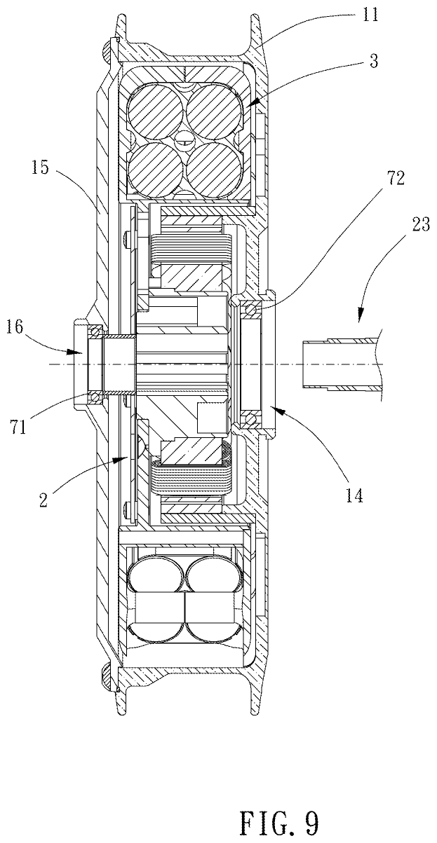

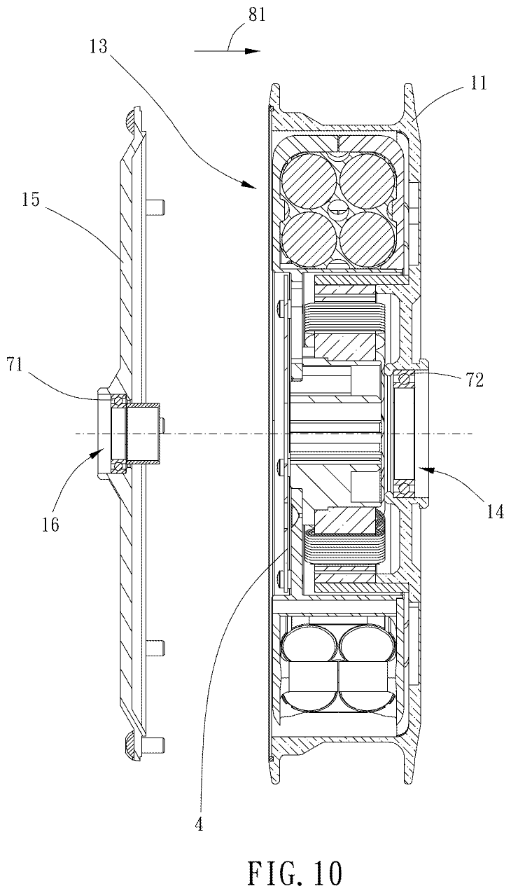

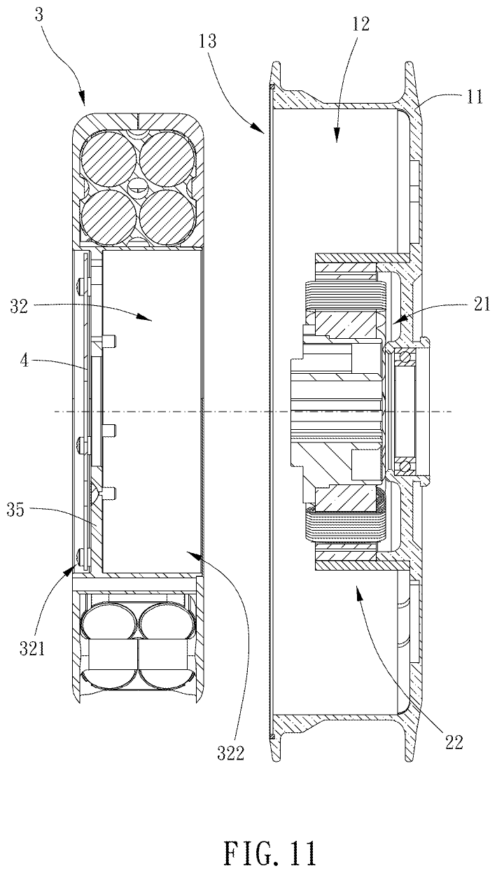

Please refer to FIGS. 1 to 11 for a preferable embodiment of the present invention. An electric wheel hub of the present invention includes a shell 1, a motor assembly 2 and a battery unit 3.

The shell 1 includes a base 11 and a cover 15, the base 11 defines an interior space 12 and a mounting entrance 13, the cover 15 is mounted to the base 11 in a mounting direction 81 and covers the mounting entrance 13. The motor assembly 2 includes a stator 21, a rotor 22 and a shaft 23, the stator 21 and the rotor 22 are received within the shell 1 by moving through the mounting entrance 13 in the mounting direction 81, the stator 21 and the rotor 22 are relatively rotatable, and the rotor 22 is connected with the shell 1. The shaft 23 is disposed within the shell 1 in a direction opposite to the mounting direction 81 and disposed through and connected with the stator 21, and two ends of the shaft 23 is configured to be respectively connected to two fork arms 91. The shaft 23 defines an axial direction 82 and a circumferential direction 83, the shaft 23 and the stator 21 are relatively movable in the axial direction 82, and the shaft 23 and the stator 21 are relatively non-rotatable in the circumferential direction 83. The battery unit 3 is electrically connected with the motor assembly 2, includes a cartridge 31 and a plurality of batteries 34, the plurality of batteries 34 are positionally received within the cartridge 31, the cartridge 31 is received within the interior space 12 by moving through the mounting entrance 13 in the mounting direction 81, and the cartridge 31 is connected with the stator 21 and disposed around the motor assembly 2.

The shaft 23 can be mechanically detached from the stator 21 so that the wheel hub can be quickly detached or installed without dismantling parts in the motor assembly 2, which is easy to uninstall/install and lowers the repairing cost. The battery unit 3 is made to be integral so that it is easy to install and maintain and is stable. In other embodiments, the battery unit 3 may be provided without the cartridge 31. The cartridge 31 is preferably made of plastic material (such as ABS-PC material) which is of good insulation.

The battery unit 3 further includes an attachment portion 35, the cartridge 31 is annular and includes a receiving space 32, the attachment portion 35 is connected with cartridge 31 and extends from a first end 321 of the receiving space 32, the motor assembly 2 is received within the receiving space 32 by moving into the receiving space 32 from a second end 322 of the receiving space 32, the first end 321 is more adjacent to the cover 15 than the second end 322, and the attachment portion 35 is connected with the stator 21. A circuit board 4 is detachably positioned to a side of the attachment portion 35 facing toward the cover 15. As the cover 15 is removed, the circuit board 4 is exposed, so that it is easy to inspect, maintain and/or repair. Preferably, the attachment portion 35 and the circuit board 4 are non-protrusive beyond the receiving space 32 so that an external impact can merely impact the shell 1 but cannot impact the circuit board 4, which is stable and durable.

Preferably, an outer circumferential wall of the cartridge 31 includes a plurality of openings 33 distanced from an inner circumferential wall of the shell 1. The cartridge 31 can be taken out from the plurality of openings 33, which helps to replace the cartridge 31.

Preferably, the plurality of batteries 34 are partially exposed from the plurality of openings. The plurality of batteries 34 can be observed from the plurality of openings 33, which helps to evaluate conditions of the plurality of batteries 34.

The shaft 23 further includes an axle 231 and a plurality of first engaging portions 24, and the plurality of first engaging portions 24 are separately arranged on the axle 231 in the circumferential direction 83. The stator 21 includes a perforation 211 and a plurality of second engaging portions 212, the plurality of second engaging portions 212 are separately arranged around the perforation 211 in the circumferential direction 83, the axle 231 is disposed through the perforation 211, the plurality of first engaging portions 24 and the plurality of second engaging portions 212 are engaged with each other, one of each said first engaging portion 24 and each said second engaging portion 212 is a first groove, and the other of each said first engaging portion 24 and each said second engaging portion 212 is a first rib, so that the shaft 23 can be removed in advance for simplifies the detachment and so that the shaft 23 and the stator 21 are not relatively rotatable and can be easily and accurately assembled.

Preferably, the shaft 23 further includes a third engaging portion 25, the stator 21 further includes a fourth engaging portion 213, and the third engaging portion 25 and the fourth engaging portion 213 are engaged with each other. One of the third engaging portion 25 and the fourth engaging portion 213 is a second groove, and the other of the third engaging portion 25 and the fourth engaging portion 213 is a second rib. The second groove is not identical to the first groove, and the second rib is not identical to the first rib, so that the shaft 23 and the stator 21 can be easily and accurately assembled.

The electric wheel hub further includes two end caps 6, the two end caps 6 are detachably disposed respectively around opposing ends of the shaft 23, and the shaft 23 is hollow and configured for a spindle 92 to be disposed therethrough. The shaft 23 which is hollow can lower the weight and increase compatibility for the spindle 92. For example, various types of end caps can be used to receive various types of the spindles (having respective diameters of 9 mm, 12 mm and 15 mm, for example). Specifically, each of the opposing ends of the shaft 23 includes a first positioning portion 237, each of the two end caps 6 includes a second positioning portion 61, and the second positioning portion 61 and the first positioning portion 237 are engaged with each other so as to provide stable and accurate combination of the two end caps 6 and the shaft 23. One of the first positioning portion 237 and the second positioning portion 61 is a projection, and the other of the first positioning portion 237 and the second positioning portion 61 is a recess.

Specifically, the electric wheel hub further includes a first bearing 71 and a second bearing 72. The cover 15 includes a first through hole 16, the base 11 includes a second through hole 14, the first bearing 71 is received in the first through hole 16, the second bearing 72 is received in the second through hole 14, and the shaft 23 is disposed through the first bearing 71 and the second bearing 72 and protrusive out beyond opposing sides of the shell 1. The shaft 23 further includes a first end portion 232, a connection portion 233, a flange 234 and a second end portion 235 in sequence. The first end portion 232 is disposed through the first bearing 71 and the cover 15, the second end portion 235 is disposed through the second bearing 72 and the base 11, the connection portion 233 includes the plurality of first engaging portions 24, and the connection portion 233 is connected with the stator 21. An intersection of the connection portion 233 and the first end portion 232 includes a stepped portion 236, the first bearing 71 is abutted against the cover 15 and the stepped portion 236 in the axial direction 82, and the second bearing 72 is abutted between the base 11 and the flange 234 between so as to improve stability of the first bearing 71 and the second bearing 72.

Since the shaft 23 is detachably connected to the stator 21, the first bearing 71 and the second bearing 72 do not have to be detached as the shaft 23 is removed, which avoids loss of the first bearing 71 and the second bearing 72, and simplifies the detachment process. To replace the first bearing 71 or the second bearing 72, the motor assembly 2 does not have to be detached, which is easy and convenient.

An electronic control unit 5 is positioned to the shaft 23 and located at a side of the base 11 opposite to the cover 15, so that the electronic control unit 5 can be individually replaced without dismantling the shell 1, which is easy and convenient.

A method of disassembling the electric wheel hub is further provided. The method includes following steps.

S1: detaching the shaft 23 along the mounting direction 81 from the shell 1 and the two fork arms 91;

S2: detaching the cover 15 from the base 11 so that the cartridge 31 is exposed from mounting entrance 13, which allows inspection, maintenance and/or repair of the circuit board 4, or allows maintenance, replacement and/or lubrication of the first bearing 71 and a second bearing 72;

S3: detaching the cartridge 31 from the stator 21, wherein the cartridge 31 can be taken out from the interior space 12 via the mounting entrance 13 along the direction opposite to the mounting direction 81, for replacement of the cartridge 31, or for maintenance and/or repair of the stator 21 and/or the rotor 22;

In sum, in the design of the electric wheel hub, the maintenance and/or replacement frequency and difficulty of different components are taken into account, which allows the maintenance and/or replacement to be carried out without dismantling the motor assembly. As a result, it can greatly simplify the difficulty of maintenance and/or replacement.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric wheel hub, including:
a shell, including a base and a cover, the base defining an interior space and a mounting entrance, the cover being mounted to the base in a mounting direction and covering the mounting entrance;
a motor assembly, including a stator, a rotor and a shaft, the stator and the rotor being received within the shell by moving through the mounting entrance in the mounting direction, the stator and the rotor being relatively rotatable, the rotor being connected with the shell, the shaft being disposed within the shell in a direction opposite to the mounting direction and disposed through and connected with the stator, two ends of the shaft being configured to be respectively connected to two fork arms, the shaft defining an axial direction and a circumferential direction, the shaft and the stator being relatively movable in the axial direction, the shaft and the stator being relatively non-rotatable in the circumferential direction; and
a battery unit, electrically connected with the motor assembly, including a cartridge and a plurality of batteries, the plurality of batteries being positionally received within the cartridge, the cartridge being received within the interior space by moving through the mounting entrance in the mounting direction, the cartridge being connected with the stator and disposed around the motor assembly.

2. The electric wheel hub of claim 1, wherein the battery unit further includes an attachment portion, the cartridge is annular and includes a receiving space, the attachment portion is connected with cartridge and extends from a first end of the receiving space, the motor assembly is received within the receiving space by moving into the receiving space from a second end of the receiving space, the first end is more adjacent to the cover than the second end, and the attachment portion is connected with the stator.

3. The electric wheel hub of claim 2, wherein a circuit board is detachably positioned to a side of the attachment portion facing toward the cover.

4. The electric wheel hub of claim 3, wherein the attachment portion and the circuit board are non-protrusive beyond the receiving space.

5. The electric wheel hub of claim 1, wherein an outer circumferential wall of the cartridge includes a plurality of openings distanced from an inner circumferential wall of the shell.

6. The electric wheel hub of claim 5, wherein the plurality of batteries are partially exposed from the plurality of openings.

7. The electric wheel hub of claim 1, further including an electronic control unit which is positioned to the shaft and located at a side of the base opposite to the cover.

8. The electric wheel hub of claim 1, wherein the shaft further includes an axle and a plurality of first engaging portions, the plurality of first engaging portions are separately arranged on the axle in the circumferential direction, the stator includes a perforation and a plurality of second engaging portions, the plurality of second engaging portions are separately arranged around the perforation in the circumferential direction, the axle is disposed through the perforation, the plurality of first engaging portions and the plurality of second engaging portions are engaged with each other, one of each said first engaging portion and each said second engaging portion is a first groove, and the other of each said first engaging portion and each said second engaging portion is a first rib.

9. The electric wheel hub of claim 4, wherein the attachment portion and the circuit board are non-protrusive beyond the receiving space; an outer circumferential wall of the cartridge includes a plurality of openings distanced from an inner circumferential wall of the shell; an electronic control unit is positioned to the shaft and located at a side of the base opposite to the cover; the shaft further includes an axle and a plurality of first engaging portions, the plurality of first engaging portions are separately arranged on the axle in the circumferential direction, the stator includes a perforation and a plurality of second engaging portions, the plurality of second engaging portions are separately arranged around the perforation in the circumferential direction, the axle is disposed through the perforation, the plurality of first engaging portions and the plurality of second engaging portions are engaged with each other, one of each said first engaging portion and each said second engaging portion is a first groove, and the other of each said first engaging portion and each said second engaging portion is a first rib; the shaft further includes a third engaging portion, the stator further includes a fourth engaging portion, the third engaging portion and the fourth engaging portion are engaged with each other, one of the third engaging portion and the fourth engaging portion is a second groove, and the other of the third engaging portion and the fourth engaging portion is a second rib; the second groove is not identical to the first groove, and the second rib is not identical to the first rib; the electric wheel hub further includes a first bearing and a second bearing, the cover includes a first through hole, the base includes a second through hole, the first bearing is received in the first through hole, the second bearing is received in the second through hole, and the shaft is disposed through the first bearing and the second bearing and protrusive out beyond opposing sides of the shell; the shaft further includes a first end portion, a connection portion, a flange and a second end portion connected in sequence; the first end portion is disposed through the first bearing and the cover, the second end portion is disposed through the second bearing and the base, the connection portion is connected with the stator, an intersection of the connection portion and the first end portion includes a stepped portion, the first bearing is abutted against the cover and the stepped portion in the axial direction, and the second bearing is abutted between the base and the flange; the electric wheel hub further includes two end caps, the two end caps are detachably disposed around opposing ends of the shaft, and the shaft is hollow and configured for a spindle to be disposed therethrough; each of the opposing ends of the shaft includes a first positioning portion, each of the two end caps includes a second positioning portion, and the second positioning portion and the first positioning portion are engaged with each other; one of the first positioning portion and the second positioning portion is a projection, and the other of the first positioning portion and the second positioning portion is a recess; the cartridge is made of plastic material.
